(19) United States
(12) Patent Application Publication
(10) Pub. No.: US 2020/0181832 A1
(43) Pub. Date: Jun. 11, 2020

(54) COLORANT CATCHER MATERIAL

(71) Applicant: BASF SE, Ludwigshafen am Rhein (DE)

(72) Inventors: Si Jun ZHU, Shanghai (CN); Laszlo SZARVAS, Central, Hong Kong (CN); Yuan Zhuo LING, Shanghai (CN); Qing SHI, Shanghai (CN)

(21) Appl. No.: 16/347,116

(22) PCT Filed: Nov. 2, 2017
(86) PCT No.: PCT/EP2017/078042

§ 371 Date: May 2, 2019

(30) Foreign Application Priority Data
Nov. 3, 2016 (CN) PCT/CN2016/104435
Mar. 27, 2017 (CN) PCT/CN2017/078307

(51) Int. Cl. D06M 13/123; C11D 3/37; C11D 3/00; C11D 7/32; D06M 13/325; D06M 13/48

(52) U.S. Cl. CPC D06M 13/123; C11D 3/3723; C11D 3/0021; D06M 15/3562; D06M 13/3255; D06M 13/48; C11D 7/3236

(57) ABSTRACT

A colorant catcher material includes a) a substrate and b) a colorant-catching additive. The colorant-catching additive is selected from the group consisting of polyvinylamines in form of homopolymers, copolymers and/or partial salts thereof, polyethylenimines in form of homopolymers, copolymers and/or partial salts thereof, and mixture thereof. The colorant-catching additive is fixed on the substrate by c) a fixing agent selected from the group consisting of dialdehydes with the carbon number of from 2 to 8. Also disclosed is a method for preparing the colorant catcher material and use of the same for catching colorants or removing dirt in an aqueous medium, particularly a laundry washing solution.

### FIELD OF THE INVENTION

This invention relates to a colorant catcher material comprising a substrate, which is made of a water-insoluble fabric, on which a colorant catching additive is fixed, a method for preparation thereof and use of the same for catching colorants or removing dirt in an aqueous medium, particularly a laundry washing solution.

### BACKGROUND

A very common problem encountered during washing process is that colorants, such as pigments or dyes, are often detached from a colored fabric, which may be referred to as “fugitive dyes” or “dye bleeding”, and then can in turn attach to lighter colored or white fabrics, which problem is often called “dye transferring”.

One approach for dealing with the undesired dye transferring is known as laundry aids. Typically, the laundry aids are provided in the form of woven or non-woven fabrics which are insoluble in the washing solution, and on which an additive, that can catch the released colorants, are supported. The laundry aids are designed to catch colorants that have detached from colored fabrics and into the washing solution before further attaching to other fabrics.

U.S. Pat. No. 3,694,364 describes a laundry aid comprising (1) a water-insoluble anionic cellulosic substrate coated with a polymeric amine of the formula

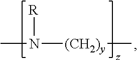

in which y is an integer of from 1 to 4, z is an integer greater than 1, R is selected from H and alkyl and alkanoyl groups containing from about 1 to about 22 carbons, from about 5% to about 100% of the nitrogen atoms in said polymeric amine being substituted with said alkyl or alkanoyl groups containing 6 to 22 carbon atoms, and (2) a detergent compound.

EP 2014754A2 describes a dye-scavenger material for the color released by laundry in washing solution comprising a substrate, which is a blend of materials selected from the group consisting of polyester, polypropylene, polylactics, polyethylenesulphone, acrylic polymers, lyocell, tencell, cotton or viscose, and an additive comprising a cationic heterocyclic polymer.

WO 96/26831A1 describes a wash additive article effective for inhibiting transfer of extraneous dyes in a wash liquor, the article comprising a support matrix for introduction into a wash liquor; a dye absorber, fixably associated with the support matrix and adapted for absorbing a first portion of said extraneous dyes; a dye transfer inhibitor releasably associated with the support matrix adapted to scavenge a second portion of said extraneous dyes. Particularly, the dye absorber is selected from the group consisting of quaternary N-substituted ammonium-hydroxy-haloalkyl compounds; salts of epoxyalkyl ammonium compounds; polyquaternary ammonium compounds; polyamphoterics; quaternized starches; proteins; chitin; hydrolyzed chitin; chitosan; choline chlorides; polyvinyl arnine; polyethylene imine; and mixtures thereof.

EP 3034594A1 describes a dye-capturing laundry aid comprising a support in the form of a sheet comprising water-insoluble fibers; a first substance anchored to the support, wherein the first substance has moieties that are cationic when exposed to water at one or more pH values in the pH range of from 6 to 10; and a second substance that coats the first substance, wherein the second substance is a polymer that remains substantially coated upon the first substance when the laundry aid is exposed to water over the pH range of from 6 to 10. Particularly, the first substance include poly(allyl amine), poly(ethyleneimine), partially hydrolyzed poly(vinylformamide), polyvinylamide, chitosan and copolymers of these polyamines with any other type of monomers.

WO 2012/078950A1 describes a visually perceivable image-forming dye scavenging article capable of absorbing and/or inhibiting transfer of fugitive dyes released during laundering, the article comprising (i) a support substrate with an imprint of an image on at least one surface of the substrate; (ii) at least one dye scavenging compound fixably adhered to the imprinted image; (iii) optionally, a film forming agent, a cross-linking agent; a rheology modifying agent; and/or a catalyst to accelerate the polymerization reaction. As the dye scavenging compound, various compounds are proposed such as polyvinyl pyrrolidone, polyvinyl polypyrrolidone, crosslinked polyvinyl pyrrolidone, polyvinyl alcohol, polyvinyl imidazole, copolymers of vinylpyrrolidone and vinyl imidazole, polyamine-N-oxides, cationic starches, magnesium aluminate, hydrotalcite, proteins, hydrolyzed proteins, polyethylene imines, polyvinyl oxazolidone, enzymes, oxidants, cationic surfactants, amphoteric surfactants, propylene oxide reaction products, polyamino acids, block co-polymers of alkylene oxides, polyamines, polyamides, methyl cellulose, carboxyalkyl celluloses, guar gum, natural gums, alginic acid, polycarboxylic acids, cyclodextrins, amine oxides, betaines, sultaines, polyquaternium compounds, mono-functional monomers, di-functional monomers, tri-functional monomers, diallyldimethyl ammonium chloride (DADMAC), diallyldimethyl ammonium bromide, diallyldimethyl ammonium sulfates, diallyldimethyl ammonium phosphates, dimethallyl dimethyl ammonium chloride, diethylallyl dimethyl ammonium chloride, diallyl-di(beta-hydroxyethyl) ammonium chloride, diallyl-di(beta-ethoxyethyl) ammonium chloride, a cyano- or guanidino-containing compound such as cyanamides or salts thereof, dicyanamides or salts thereof, dicyandiamides or salts thereof, guanidines or salts thereof, biguanidines or salts thereof.

EP 2447412A1 describes a “colour-fast” material comprising a substrate selected among the group consisting of natural and/or synthetic fabric, natural and/or synthetic non-woven fabric, paper and felt and as “colour-fast” additive a polyamide cationic resin comprising a copolymer of adipic acid with chloromethyloxirane, diethylenetriamine and epichlorohydrin.

WO 02/33040A1 describes a laundry additive article effective for selectively absorbing and inhibiting transfer of extraneous dyes in a wash solution, said article comprising: a) an insoluble substrate for introduction into a wash solution; b) a dye absorber comprising a substantially insoluble polymeric amine fixably adhered to said substrate; c) optionally, a dye transfer inhibitor releasably associated with said substrate. The dye absorber is selected from the group consisting of cross-linked amine polymers formed by copolymerizing vinyl or acrylic type monomers having an amine group with a monomer having a group capable of forming branches and crosslinked amine polymers formed by cross-linking soluble amine containing molecules with reactive cross-linking agents.

### SUMMARY OF THE INVENTION

Although numerous laundry aids intended to solve the dye transferring problem have been proposed in the last decades, the problem remains that colorant-catching substances, which may have or have not caught colorants, are released into the washing solution to some extent. The released colorant-catching substances will be attracted to the laundry, which may cause fixation of colorants present in the washing solution onto the laundry once the colorants had been caught.

For instance, EP2014754 A2 mentioned above relates to a dye-scavenger material for the color released by laundry in washing solution comprising a substrate and an additive selected from: cationic heterocyclic polymers, proteins, chitin, chitosan, polyvinylamine (PVA), polyethylenimine (PEI), acrylic polymers, vinylic polymers, polyamine-N-oxide and their blends. EP2014754 also describes a process for the production of the dye scavenger, wherein said process comprises the following steps of providing a substrate comprising one material selected from natural and/or synthetic fabric, natural and/or synthetic non-woven fabric and paper, processing the substrate with an additive, passing the processed substrate through two or more rollers in order to remove any excess additive and finally drying the substrate. EP2014754 remains silent with regard to the use of a fixing agent or fixing agent administering process step.

It is therefore an object of the present invention to provide a colorant catcher material comprising a substrate and a colorant-catching additive fixed on the substrate as a laundry aid, which can effectively catch the colorants detached from a colored fabric into the washing solution and thus preventing the colorants from redeposition on other fabrics from the laundry in the same washing solution, and prevent the colorant-catching additive of releasing back into the washing solution.

Besides the colorant catcher function, it is also an object of the present invention to apply and use the capacity and efficacy of the laundry aid according to the present invention to remove further unwanted substances, other than fugitive dyes, from the washing solution, such as dirt particles or bacterial contamination, hence to benefit from these additional advantageous effects in the laundry process (e.g. the mentioned antibacterial function in order to disinfect the laundry).

Accordingly, the present invention provides primarily a colorant catcher material for catching colorants in an aqueous medium, especially for catching colorants released by laundry in a washing solution. The colorant catcher material according to the present invention contains polyvinylamine (PVA) or polyethylenimine (PEI) as the colorant-catching additive which is in turn fixed by a fixing agent. The colorant catcher material according to the present invention achieves a significantly improved colorant catching performance over the dye-scavenger material containing polyvinylamine (PVA) or polyethylenimine (PEI) without fixation. This and other aspects are described as follows.

In the first aspect, the present invention provides a colorant catcher material, comprising

a) a substrate,

b) a colorant-catching additive selected from the group consisting of polyvinylamines in form of homopolymers, copolymers and/or partial salts thereof, polyethylenimines in form of homopolymers, copolymers and/or partial salts thereof, and mixture thereof, which is fixed on the substrate by

c) a fixing agent selected from the group consisting of dialdehydes with the carbon number of from 2 to 8.

In the second aspect, the present invention provides a method for producing the colorant catcher material according to the first aspect of the present invention, comprising

a) Providing a substrate;

b) Incorporating a colorant-catching additive into the substrate, the colorant-catching additive being selected from the group consisting of polyvinylamines in form of homopolymers, copolymers and/or partial salts thereof, polyethylenimines in form of homopolymers, copolymers and/or partial salts thereof, and mixture thereof, to obtain a substrate loaded with the colorant-catching additive;

c) Optionally, removing any excess colorant-catching additive from the substrate loaded with the colorant-catching additive, and

d) Further treating the substrate loaded with the colorant-catching additive with a fixing agent selected from the group consisting of dialdehydes with the carbon number of from 2 to 8.

In the third aspect, the present invention provides use of the colorant catcher material according to the first aspect of the present invention, or the colorant catcher material obtained by the method according the second aspect of the present invention, for catching colorants present in an aqueous medium, particularly a laundry washing solution.

In the fourth aspect, the present invention provides use of the colorant catcher material according to the first aspect of the present invention, or the colorant catcher material obtained by the method according the second aspect of the present invention, for removing dirt present in an aqueous medium, particularly a laundry washing solution.

In the fifth aspect, the present invention provides use of the colorant catcher material according to the first aspect of the present invention, or the colorant catcher material obtained by the method according the second aspect of the present invention, for exhibiting antimicrobial activity against pathogenic bacteria, particularly in a laundry washing solution.

In the sixth aspect, the present invention provides use of the colorant catcher material according to the first aspect of the present invention, or the colorant catcher material obtained by the method according the second aspect of the present invention, as a gas scavenger to remove toxic gas or acid gas.

### DESCRIPTION OF THE FIGURES

FIG. 1 shows appearances of an effluent sample from a cloth printing plant before the treatment according to Inventive Example 5 (left) and after the treatment (right).

FIG. 2 shows appearances of an effluent sample from a cloth dyeing plant before the treatment according to Inventive Example 6 (left) and after the treatment (right).

### DETAILED DESCRIPTION OF THE INVENTION

In the first aspect, the present invention provides a colorant catcher material, comprising

a) a substrate,

b) a colorant-catching additive selected from the group consisting of polyvinylamines in form of homopolymers, copolymers and/or partial salts thereof, polyethylenimines in form of homopolymers, copolymers and/or partial salts thereof, and mixture thereof, which is fixed on the substrate by

c) a fixing agent selected from the group consisting of dialdehydes with the carbon number of from 2 to 8.

The substrate is made of a fabric, which functions as a solid carrier of the colorant-catching additive which can catch colorants present in an aqueous medium, especially in the laundry washing solution. The caught colorants are in turn constrained on the substrate together with the colorant-catching additive.

The substrate may be any types of materials that do not dissolve in water and are compatible to for example normal washing temperatures and common laundry detergent formulations, and thus can survive the laundering process. Generally, the substrate is a natural and/or synthetic fabric, preferably a natural and/or synthetic non-woven fabric and/or paper. Preferably, the substrate is a natural and/or synthetic nonwoven fabric, and more preferably a synthetic non-woven fabric.

There is no limitation to the form, shape and size of the substrate. The substrate is typically in a form of sheet, for example a handkerchief or a piece of cloth in any shapes such as rectangular, square, triangular, hexagonal, oval, circular, etc. Preferably, the substrate has the form of a handkerchief for the application in a laundry washing solution. The size of the substrate is not particularly limited, which can be any sizes of the commercially available fabrics. The substrate and thus the prepared colorant catcher material in the finished form for household use will generally has a size of, for example but not limited to, from 5 to 15 cm and preferably from 7 to 10 cm in width, from 10 to 25 cm and preferably 15 to 20 cm in length, and from 0.1 to 1.0 mm and preferably 0.3 to 0.7 mm in thickness.

Non-woven fabrics that are preferably used as the substrate are known from the state of art. Those conveniently used are spunlaced, spunbonded, thermobonded, and airlaided materials, as described in EP 2014754A2. According to the disclosure in the EP patent application, the fibres preferably used to obtain the non-woven fabrics are made of polyester such as polyethylene terephthalate (PET), polypropylene(PP), PLA (polylactics), polyethersulfone (PES), acrylic polymers, nylon, perlon, regenerated cellulose, for example, Lyocell® (that is regenerated cellulose fibre, obtained using a process of dissolving and spinning in organic solvent) or Tencell® (produced in three layers with the fibres on the two external sides and fluff pulp in the middle; or produced in two layers of fibre/fluff pulp), cotton, viscose or their blends.

According to the present invention, it is preferable that the fibers used to obtain the non-woven fabrics are made of polyester such as polyethylene terephthalate (PET), Lyocell®, Tencell®, cotton, viscose or blends thereof.

Wood Pulp for instance, is a derived natural material made from pulp, which originates from wood (most often softwood, but sometimes also hardwood) and which is absorbent and very often used as a raw material for forming paper and nonwoven fiber webs. The fabrics made of wood pulp are in general suited for use where such characteristic is desirable, e.g. also for the purpose of the present invention.

Especially Wood pulp spunlace composite nonwoven, which is made of wood pulp and other fibers (including but not limited to PP, PET, viscose and their blend) has a porous structure which increase the absorption speed of cationic nonwovens. Used as a substrate according to the present invention it provides an excellent anti-stain function and colorant catcher capability to the fabric in laundry process.

The substrate preferably has a weight in the range of from 30 grams/m² to 100 grams/m², more preferably from 40 grams/m² to 80 grams/m². The fibres from which the substrate is fabricated preferably have a size in the range of from 0.1 dtex to 5 dtex, preferably from 0.1 dtex to 2 dtex.

For the purpose of the present invention, the colorant-catching additive is selected from the group consisting of polyvinylamines in form of homopolymers, copolymers and/or partial salts thereof, polyethylenimines in form of homopolymers, copolymers and/or partial salts thereof, derivatives and mixture thereof.

Polyvinylamines and polyethylenimines are well known cationic nitrogen-containing polymers. Polyvinylamines and polyethylenimines in form of homopolymers, copolymers and/or partial salts thereof, derivatives and mixture thereof to be used as the colorant-catching additive can be prepared in accordance with any processes known in the state of art or can be any commercially available ones.

According to the present invention, preferred polyvinylamines suitable as the colorant-catching additive typically have a weight-average molecular weight Mw as measured by Gel Permeation Chromatography-Light Scattering (GPC-LS) method in the range of from 1,000 to 1,000,000, preferably 5,000 to 500,000, more preferably 10,000 to 400,000, most preferably 40,000 to 300,000.

Preferred polyethylenimines suitable as the colorant-catching additive typically have a weight-average molecular weight Mw as measured by GPC-LS method in the range of from 300 to 10,000,000, preferably 10,000 to 6,000,000, more preferably 25,000 to 4,000,000, still preferably 200,000 to 3,000,000, most preferably 750,000 to 2,000,000.

There is no particular limitation to the cationic charge densities of the polyvinylamines and polyethylenimines suitable as the colorant-catching additive, which vary greatly depending on the pH of application environment. The cationic charge density of the polyvinylamines suitable as the colorant-catching additive may be, for example, in the range of 10 to 20 meq/g as measured at pH of 4.5, and the cationic charge density of the polyethylenimines suitable as the colorant-cataching additive may be, for example, in the range of 5 to 19 meq/g as measured at pH of 4.5.

There are various existing processes for preparing polyvinylamines, for example, by free radical polymerization of N-vinylamides such as N-vinylformamide, N-vinylacetamide, N-vinylpropionamide, N-vinylbutyramide with subsequent hydrolysis of the polymers; or by Hofmann rearrangement of polymers of acrylamides such as (meth)acrylamide, N—C₁₋₆-alkyl (meth)acrylamide, N,N-di(C₁₋₆-alkyl) (meth)acrylamide, di(C₁₋₆-alkyl)aminoethyl (meth)acrylamide, di(C₁₋₆-alkyl)aminopropyl (meth)acrylamide, diacetone acrylamide, etc., as described in Polyvinylamine: A Tool for Engineering Interfaces, Robert Pelton, Langmuir, 30 (51), 15373-15382, 2014.

Suitable processes for preparing polyethylenimines are also well known. For example, linear polyethylenimines can be prepared for example by post-modification of other polymers such as poly(2-oxazolines), as described in High Molecular Weight Linear Polyethylenimine and Poly(N-methylethylenimine), Tanaka, Ryuichi, et al, Macromolecules. 16 (6), 849-853, 1983, or N-substituted polyaziridines, as described in New Synthesis of Linear Polyethylenimine, Weyts, Katrien F. and Goethals, Eric J., Polymer Bulletin, 19 (1), 13-19, 1988; branched polyethylenimines can be prepared for example by the ring opening polymerization of aziridine, which has been developed for a long time, for example as described in Advances in the Chemistry of Polyethyleneimine(Polyaziridine), Zhuk, D. S., Gembitskii, P. A., and Kargin V. A., Russian Chemical Reviews, Vol 34 (7), 515-526, 1965.

In case that the colorant-catching additive is polyvinylamines or polyethylenimines in form of a copolymer, there is no particular limitation to the comonomers. Any conventional comonomers that may be copolymerized to form copolymers of vinylamine or copolymers of ethylenimines may be used.

The polyvinylamines or polyethylenimines, homopolymers or copolymers, may be in form of any suitable salts, especially when used in an aqueous medium at a certain pH value, for example, but not limited to, the range of from 6 to 10. Counterions that may be present in the salts are not particularly limited. Suitable counterions are for example, but not limited to, halide anions such as chloride anion, sulfate anion and sulfonate anions.

It is to be understood that commercially available polyvinylamines and polyethylenimines may be used according to the present invention.

For the purpose of the present invention, the fixing agent is selected from the group consisting of C₂-C₈-dialdehydes, meaning with the carbon number of from 2 to 8, preferably glyoxal, malondialdehyde, succinaldehyde, glutaraldehyde and adipaldehyde, more preferably glyoxal and glutaraldehyde.

According to the present invention, the colorant-catching additive is fixed on the substrate by the fixing agent. Without being bound by any particular theory, it is believed that the fixing agent effectively improves the attachment of the colorant-catching additive to the substrate, for example by crosslinking the fiber material, such as acrylic polymers, nylon, perlon, regenerated cellulose such as Lyocell® and Tencell®, or viscose, of the substrate and the colorant-catching additive, or forming a three-dimensional network with the colorant-catching additive in the substrate. Through the fixation by the fixing agent, no or little detachment of the colorant-catching additive from the substrate and thus release thereof into the washing solution occur.

It is desirable that the colorant-catching additive is loaded on the substrate in an amount of from 1% to 50% by weight based on the substrate, preferably from 5% to 30% by weight, more preferably from 6% to 24% by weight.

It is also desirable that the fixing agent is loaded on the substrate in an amount of from 0.1% to 10% by weight based on the substrate, preferably from 0.6% to 5% by weight, more preferably from 0.8% to 3% by weight.

In addition or alternatively, it is preferable that the colorant-catching additive and the fixing agent are comprised in the finished colorant catcher material at a weight ratio in the range of from 50:1 to 1:10, more preferably from 20:1 to 1:1, still preferably 12:1 to 4:1.

In the second aspect, the present invention provides a method for producing the colorant catcher material according to the first aspect of the present invention.

According to the present invention, the method for producing the colorant catcher material comprises:

a) Providing a substrate;

b) Incorporating a colorant-catching additive into the substrate, the colorant-catching additive being selected from the group consisting of polyvinylamines in form of homopolymers, copolymers and/or partial salts thereof, polyethylenimines in form of homopolymers, copolymers and/or partial salts thereof, and mixture thereof, to obtain a substrate loaded with the colorant-catching additive;

c) Optionally, removing any excess colorant-catching additive from the substrate loaded with the colorant-catching additive, and

d) Further treating the substrate loaded with the colorant-catching additive with a fixing agent.

It is to be understood that the substrate, the colorant-catching additive and the fixing agent to be used in the method according to the second aspect of the present invention are to produce—as described hereinabove—the colorant catcher material according to the first aspect of the present invention. All features and corresponding preferences described hereinabove for the colorant catcher material can be applied accordingly for the method of producing the colorant catcher according to the second aspect.

In step b), the incorporation of the colorant-catching additive is not particularly limited, which can be effected by for example impregnation, spraying, printing and/or plating. Preferably, the colorant-catching additive is incorporated by spraying and/or impregnation into the substrate, and more preferably by impregnation.

According to a preferable embodiment in which the colorant-catching additive is incorporated into the substrate by impregnation, the substrate is immersed into or passed through a solution of the colorant-catching additive. There is no particular limitation to the concentration of colorant-catching additive in the solution with the provision that effective amount of colorant-catching additive can be loaded in the finished material. Generally, the concentration of colorant-catching additive in the solution is in the range of from 20 to 300 g/L, preferably from 50 to 250 g/L, more preferably from 80 to 150 g/L.

The solution of the colorant-catching additive may additionally contain other ingredients, when necessary. Particularly, nonionic surfactants can be added into the solution of the colorant-catching additive to facilitate penetration of the colorant-catching additive into the substrate. The nonionic surfactants are preferably selected from long chain alcohol polyethylene glycol/polypropylene glycol ethers or long chain alcohol polypropylene glycol/polyethylene glycol ethers, for example, C₁₀-Guerbet ethylene glycol ether, and fatty acid C₁₋₁₀ alkyl esters and amine oxides, long chain alcohol alkoxylates such as long chain alcohol ethoxylates, wherein the long chain alcohols are preferably selected from fatty alcohols such as Guerbet alcohols, cetyl alcohol, stearyl alcohol, and cetostearyl alcohol consisting predominantly of cetyl and stearyl alcohols, and oleyl alcohol. The concentration of the nonionic surfactants, when used, is generally in the range of from above 0 to 5 g/L, preferably from 1 to 3 g/L.

Optionally, the method according to the present invention comprises a step c) for removing any excess colorant-catching additive from the substrate loaded with the colorant-catching additive before the treatment with a fixing agent in step d), especially in the case where impregnation is used to incorporate the colorant-catching additive into the substrate in step b). Typically, the removal can be effected by passing the substrate loaded with the colorant-catching additive through an apparatus comprising one or more rollers in order to leave on the substrate the required amount of the colorant-catching additive. Any apparatuses containing one or more roller can be used for this purpose, such as kiss rollers or foulards. One apparatus suitable for this purpose is for example Pneumtic Type Horizonal Padding Mangle Model P-BO, commercially available from Xiamen Rapid Precion machinery Co., LtD. China.

The pressing pressure will depend on the amount of the colorant-catching additive to be left in the finished material, on the concentration of the solution and/or on the type and water content of the substrate as provided in step a). In general, a pressing pressure of from 0.5 to 6 bar can be used, preferably a pressure of from 2 to 4 bar being applied.

For example, in order to obtain a finished material comprising an amount of colorant-catching additive in the range of from 6% to 24% by weight, if a solution of the colorant-catching additive having a concentration of from 100 to 180 g/L is used, the pressing pressure can vary from 0.5 to 6 bar, preferably from 2 to 4 bar.

The steps b) and c) can be carried out at any suitable temperatures that will not change the properties of the substrate and the colorant-catching additive. It is preferable that both step b) and c) are effected at room temperature, for example 23° C.

In step d), the substrate loaded with the colorant-catching additive obtained from step b) or step c), if step c) is carried out, was subjected to a treatment with the fixing agent. The treatment in step d) can be effected by any suitable means that introduce the fixing agent into the substrate loaded with the colorant-catching additive obtained from step b) or step c), if step c) is carried out, for example by impregnation or spraying.

According to a preferable embodiment in which the fixing agent is introduced into the substrate loaded with the colorant-catching additive by impregnation, said substrate is immersed into or passed through a solution of the fixing agent. The treatment with fixing agent will generally be carried out at a temperature in the range of from 10° C. to 50° C., preferably from 15° C. to 30° C., and more preferably 20° C. to 25° C. There is no particular limitation to the concentration of the fixing agent in the solution with the provision that effective amount of fixing agent are available for fixing the colorant-catching additive to the substrate. The amount of the fixing agent will depend on the colorant-catching additive to be left on the finished materials and may be adjusted by controlling the concentration of the fixing agent and/or the time of period for the treatment with the fixing agent. It is desirable that the concentration of fixing agent in the solution is in the range of from 1 to 100 g/L, preferably from 5 to 30 g/L, more preferably from 6 to 20 g/L.

As described hereinabove for the first aspect of the present invention, it is preferable that the colorant-catching additive and the fixing agent are comprised in the finished colorant catcher material at a weight ratio in the range of from 50:1 to 1:10, more preferably from 20:1 to 1:1, still preferably 12:1 to 4:1.

Water is preferable as the solvent for both the solution of the colorant-catching additive used in step b) and the solution of the fixing agent used in step d), because of the fact that the colorant-catching additive selected from polyvinylamines in form of homopolymers, copolymers and/or partial salts thereof, polyethylenimines in form of homopolymers, copolymers and/or partial salts thereof and mixture thereof has good solubility in water.

According to the present invention, the method for producing the colorant catcher material further comprises a step e) for drying the substrate which has been subjected to the treatment with the fixing agent in step d).

In step e), the substrate which has been subjected to the treatment with the fixing agent is dried, preferably in an oven, at a temperature in the range of from 100° C. and 220° C., preferably from 120° C. to 170° C., for a period of time that depends on the amounts of the colorant-catching additive, the fixing agent and the solvent present, on the type of the substrate as provided in step a), on the temperature and/or the efficiency of the drying system.

The method for producing the colorant catcher material according to the present invention may be performed continuously, that is, the substrate is subjected to incorporation of the colorant-catching additive for example by impregnation, optional removal of any excess colorant-catching additive by for example pressing, treatment by the fixing agent by for example impregnation and drying without any intermediate stages or pauses.

The colorant catcher material according the first aspect of the present invention or the colorant catcher material obtainable or obtained by the method according the second aspect of the present invention may be used in any an aqueous medium which contain free colorants that need to be caught, especially a laundry washing solution.

Particularly, in case of use in a laundry washing solution, the colorant catcher material can be normally introduced into conventional domestic or professional washing machines before the beginning of the washing cycle.

The colorant catcher material is not only effective for catching reactive dyes which may comprise for example, but not limited to, C.I. Reactive Yellow 2, C.I. Reactive Yellow 125, C.I. Reactive Yellow 158, C.I. Reactive Yellow 14, C.I. Reactive Red 1, C.I. Reactive Red 120, C.I. Reactive Red 241, C.I. Reactive Red 158, C.I. Reactive Red 35, C.I. Reactive Green 6, C.I. Reactive Green 8, C.I. Reactive Blue 19, C.I. Reactive Blue 181, C.I. Reactive Blue 162, C.I. Reactive Blue 221, C.I. Reactive Orange 5, C.I. Reactive Orange 13, C.I. Reactive Orange 127, C.I. Reactive Orange 122, C.I. Reactive Brown 11, C.I. Reactive Brown 23, C.I. Reactive Violet 4, C.I. Reactive Violet 33, C.I. Reactive Violet 12, C.I. Reactive Black 8, C.I. Reactive Black 5 and C.I. Reactive Black 11, but is also effective for catching disperse dyes which may comprise for example, but not limited to, C.I. Disperse Yellow 184:1, C.I. Disperse Yellow 64, C.I. Disperse Yellow 82, C.I. Disperse Yellow 79, C.I. Disperse Yellow 114, C.I. Disperse Yellow 236, C.I. Disperse Yellow 211, C.I. Disperse Green 5, C.I. Disperse Green 9, C.I. Disperse Green 6:1, C.I. Disperse Orange 25, C.I. Disperse Orange 44, C.I. Disperse Orange 44, C.I. Disperse Orange 30, C.I. Disperse Orange 30:1, C.I. Disperse Red 374, C.I. Disperse Red 22, C.I. Disperse Red 9, C.I. Disperse Red 152, C.I. Disperse Red 364, C.I. Disperse Red 343, C.I. Disperse Red 60, C.I. Disperse Red 92, C.I. Disperse Red 50, C.I. Disperse Red 153, C.I. Disperse Red 26, C.I. Disperse Red 11, C.I. Disperse Red 277, C.I. Disperse Red 54, C.I. Disperse Red 202, C.I. Disperse Red 91, C.I. Disperse Red 167:1, C.I. Disperse Violet 1, C.I. Disperse Violet 27, C.I. Disperse Violet 31, C.I. Disperse Violet 57, C.I. Disperse Brown 21, C.I. Disperse Brown 1, C.I. Disperse Brown 19, C.I. Disperse Blue 79:1, C.I. Disperse Blue 94, C.I. Disperse Blue 56, C.I. Disperse Blue 60, C.I. Disperse Blue 354, C.I. Disperse Blue 366, C.I. Disperse Blue 165, C.I. Disperse Blue 183, C.I. Disperse Blue 183, C.I. Disperse Blue 291, C.I. Disperse Blue 73, C.I. Disperse Black 1, C.I. Disperse Black 9, C.I. Disperse Black 14 and C.I. Disperse Black 26.

Accordingly, in the third aspect, the present invention relates to use of the colorant catcher material according the first aspect of the present invention or the colorant catcher material obtainable or obtained by the method for producing the colorant catcher material according the second aspect of the present invention for catching colorants present in an aqueous medium, especially a laundry washing solution.

In a preferable embodiment according to the third aspect of the present invention, the substrate is in a form of sheet, for example a handkerchief or a piece of cloth, in any shapes such as rectangular, square, triangular, hexagonal, oval, circular, etc. More preferably, the substrate has the form of a handkerchief for the application in a laundry washing solution.

The size of the colorant catcher material sheets is not particularly limited, which can be any typically adopted sizes. For example, and without limiting to the size given hereinafter, the colorant catcher material sheets to be used during laundering may have a length of 15 cm and a width of 10 cm, which would be applicable for instance for household use.

The colorant catcher material as described hereinabove may be introduced into the washing machine together with lighter colored and darker colored fabrics. The number of the colorant catcher material sheets to be used for each wash depends on the weight of laundry and the colorants present. For example, 2 or more sheets of the colorant catcher material may be required in case of fabrics that generally have a severe dye transferring problem, for example cotton fabrics with strong intense colors. For the laundering application, the colorant catcher material is generally and preferably used once. It is to be understood that the colorant catcher material is not limited to single use, which in principle can be used again as long as the colorant catcher material still has a capacity to further catch colorants.

It is to be understood that the colorant catcher material according to the present invention can be used in any aqueous mediums other than laundry washing solution where free colorants are need to be caught. The colorant catcher material according to the present invention may also be used for example, but not limited to, for treating effluents from cloth printing or dyeing plants which comprises pigments or dyes that need to be removed before the effluents are discharged from the plants.

The colorant catcher material according to the present invention was also found effective for removing dirt or dirt particles in an aqueous medium, especially a laundry washing solution. The dirt attached to laundry that need to be cleaned includes, but not limit to, powders of organic or mineral matter (dust); foul matter such as excrement, ingrained dust such as soot, and soil, which is generally a mix of clay, sand and humus which lies on top of bedrock.

Accordingly, in the fourth aspect, the present invention relates to use of the colorant catcher material according the first aspect of the present invention or the colorant catcher material obtained by the method for producing the colorant catcher material according the second aspect of the present invention for removing dirt or dirt particles present in an aqueous medium, particularly a laundry washing solution.

The colorant catcher material according to the present invention was further found effective for exhibiting antimicrobial activity against bacteria, such as pathogenic bacteria, in an aqueous medium, especially in a laundry washing solution. The laundry that need to be disinfected or to undergo an anti-bacterial treatment may be contaminated with pathogenic bacteria such as, without being limited to, Staphylococcus aureus (S. aureus) and/or Escherichia coli (E. Coli).

Accordingly, in the fifth aspect, the present invention relates to use of the colorant catcher obtained by the method according the second aspect of the present invention for exhibiting antimicrobial activity against pathogenic bacteria present in an aqueous medium, particularly in a laundry washing solution.

The colorant catcher material according to the present invention may furthermore be effective for absorbing gases. Hence, the colorant catcher material according to the present invention could also be used as absorbent for environment purification, because of it's potential to absorb toxic or harmful gas, such as formaldehyde, sulfur dioxide, ammonia, etc.

Accordingly, in the sixth aspect, the present invention provides use of the colorant catcher material according the first aspect of the present invention or the colorant catcher material obtained by the method according the second aspect of the present invention as a gas scavenger to remove a gas, e.g. toxic gas or acid gas.

### EXAMPLES

Certain aspects of the present invention are illustrated in detail by way of the following examples. The examples are given here for illustration purpose and are not intended to limit the present invention.

In the Examples hereinafter, showing the preparation of the colorant catcher material according to the present invention, the following solutions, formulations or liquids comprising the colorant-catching additive selected from the listed polymers or comprising a non-ionic surfactant are used:

Solution A: 50% aqueous solution of polyethyleneimine with a molecular weight Mw of 750,000;

Solution B: 24% aqueous solution of polyethyleneimine with a molecular weight Mw of 2,000,000;

Solution C: 22.5% aqueous solution of polyvinylamine with a molecular weight Mw of about 45,000 g/mol, degree of hydrolysis of 95%;

Liquid D: a nonionic surfactant, which is an alkyl poly-propylene and ethylene glycol ether made from a C₁₀-Guerbet Alcohol and ethylene oxide (about 7 EO).

### Inventive Preparation Example 1—Preparation of a Colorant Catcher Material According to the Present Invention Comprising a Viscose Substrate

A polyethyleneimine solution was prepared by mixing 0.8 litre of water with 200 grams of Solution A (a 50% aqueous solution of polyethylenimine having a weight average molecular weight Mw of 750,000). A separate solution was prepared by mixing 0.95 litre of water with 50 grams of glutaraldehyde. A piece of 100% viscose spunlaced nonwoven fabric with a weight of 70 grams/m² was impregnated into a bath containing the polyethylenimine solution, then passed through one roller at a pressure of 4 bar with the uploading rate of 100% (which is an amount calculated according to the formula: Uploading rate=(Weight of the fabric passed through the roller—Initial weight of the fabric)/Initial weight of the fabric). Next, the fabric was impregnated into a bath containing said solution of glutaraldehyde for 3 seconds, removed, and finally dried in an oven at 170° C. for 3 minutes. Compared with the initial fabric, the weight increase of the final finished fabric is 12.5%.

### Comparative Preparation Example 1—Preparation of a Colorant Catcher Material without Treatment with Fixing Agent Comprising a Viscose Substrate

A polyethylenimine solution was prepared by mixing 0.8 litre of water with 200 grams of Solution A (a 50% aqueous solution of polyethylenimine having a weight average molecular weight Mw of 750,000). A piece of 100% viscose spunlaced nonwoven fabric with a weight of 70 grams/m² was impregnated into a bath containing the polyethylenimine solution, then passed through one roller at a pressure of 4 bar with the uploading rate of 100%. Then, the prepared fabric was dried in an oven at 170° C. for 3 minutes. Compared with the initial fabric, the weight increase of the final finished fabric is 10%.

### Inventive Preparation Example 1.1—Preparation of a Colorant Catcher Material According to the Present Invention Comprising a Wood Pulp Blend Substrate

A polyethyleneimine solution was prepared by mixing 0.8 litre of water with 200 grams of Solution A (a 50% aqueous solution of polyethylenimine having a weight average molecular weight Mw of 750,000). A separate solution was prepared by mixing 0.95 litre of water with 50 grams of glutaraldehyde. A piece of woodpulp spunlace composite nonwoven (70% woodpulp, 30% PP fiber) fabric with a weight of 60 grams/m2 was impregnated into a bath containing the polyethylenimine solution, then passed through one roller at a pressure of 4 bar with the uploading rate of 110% (which is an amount calculated according to the formula: Uploading rate=(Weight of the fabric passed through the roller—Initial weight of the fabric)/Initial weight of the fabric). Next, the fabric was impregnated into a bath containing said solution of glutaraldehyde for 3 seconds, removed, and finally dried in an oven at 170° C. for 3 minutes. Compared with the initial fabric, the weight increase of the final finished fabric is 12%.

Washing Test

A dye solution was prepared by mixing 0.5 grams of C.I. Disperse Blue 56 and 0.5 grams of C.I. Reactive Blue 19 in one litre of water. A sheet of the colorant catcher material (3 g) from Inventive Example 1 or Comparative Example 1 and a sheet of white cotton woven fabric (3 g) were immersed into a bath containing 30 g of said dye solution, and then stirred at 23° C. for 10 minutes. The fabrics were removed from the bath. The white cotton woven fabric was dried and measured for the color change in terms of ΔE.

ΔE is calculated as CIE 1976 L*a*b* Colour Space (ISO 11664-4:2008) and English translation of DIN EN ISO 11664-4:2012-06 in accordance with following equation:

ΔE=(ΔL*²+Δa*²+Δb*²)^{1/2}
in which
ΔL*=L*_{washed}−L*ᵢₙᵢₜᵢₐₗ;
Δa*=a*_{washed}−a*ᵢₙᵢₜᵢₐₗ; and
Δb*=b*_{washed}−b*ᵢₙᵢₜᵢₐₗ.

The values L*ᵢₙᵢₜᵢₐₗ, a*ᵢₙᵢₜᵢₐₗ, and b*ᵢₙᵢₜᵢₐₗ were measured on the white cotton woven fabric before washing. The values L*_{washed}, a*_{washed} and b*_{washed} were measured on the white cotton woven fabric after washing. The L*, a* and b* values can be measured by a spectrophotometer, which is typically a Diffuse/0 spectrophotometer, such as Datacolor ELREPHO, which is commercially available from Datacolor Inc., although other types of spectrophotometers can also be used.

### Comparative Example 2 (Blank)

The washing test was repeated except that no colorant catcher material was used.

The results are shown in Table 1.

TABLE 1

| | | | | Comparative |
|---|---|---|---|---|
| | Inventive | Comparative | Inventive | Example 2, |
| | Example 1 | Example 1 | Example 1.1 | Blank |
| ΔE | 1.77 | 5.68 | 1.04 | 7.13 |

### Inventive Preparation Example 2—Preparation of a Colorant Catcher Material According to the Present Invention Comprising a Viscose Blend Substrate

A polyethylenimine solution was prepared by mixing 0.58 litre of water with 416 grams of Solution B (a 24% aqueous solution of polyethylenimine having a weight average molecular weight Mw of 2,000,000) and 2 grams of a nonionic surfactant (Liquid D, an alkyl poly-propylene and ethylene glycol ether made from a C₁₀-Guerbet Alcohol and ethylene oxide (about 7 EO)). A separate solution was prepared by mixing 0.95 litre of water with 50 grams of glutaraldehyde. A piece of viscose (50%)/PET(50%) blend spunlaced nonwoven fabric with a weight of 70 grams/m² was impregnated into a bath containing the polyethylenimine solution, then passed through one roller at a pressure of 4 bar with the uploading rate of 100%. Next, the fabric was impregnated into a bath containing said solution of glutaraldehyde for 3 seconds, removed and finally dried in an oven at 170° C. for 3 minutes. Compared with the initial fabric, the weight increase of the final finished fabric is 10%.

### Comparative Preparation Example 3—Preparation of a Colorant Catcher Material without Treatment with Fixing Agent Comprising a Viscose Blend Substrate

A solution was prepared by mixing 0.58 litre of water with 416 grams of Solution B (a 24% aqueous solution of polyethylenimine having a weight average molecular weight Mw of 2,000,000) and 2 grams of nonionic surfactant (Liquid D, an alkyl poly-propylene and ethylene glycol ether made from a C₁₀-Guerbet Alcohol and ethylene oxide (about 7 EO)). A piece of viscose(50%)/PET(50%) blend spunlaced nonwoven fabric with a weight of 70 grams/m² was impregnated into a bath containing the polyethylenimine solution, then passed through one roller at a pressure of 4 bar with the uploading rate at 100%. Then, the fabric was dried in an oven at 170° C. for 3 minutes. Compared with the initial fabric, the weight increase of the final finished fabric is 10%.

Washing Test

A dye solution was prepared by mixing 0.5 grams of C.I. Disperse Blue 56 and 0.5 grams of C.I. Reactive Blue 19 in one litre of water. A sheet of the colorant catcher material (3 g) from Inventive Example 2 or Comparative Example 3 and a sheet of white cotton woven fabric (3 g) were immersed into a bath containing 30 g of said dye solution, and then stirred at 23° C. for 10 minutes. The fabrics were removed from the bath. The white cotton woven fabric was dried and measured for the color change in terms of ΔE as described above.

### Comparative Example 4 (Blank)

The washing test was repeated except that no colorant catcher material was used.

The results are shown in Table 2.

TABLE 2

| | | Comparative | Comparative |
|---|---|---|---|
| | Inventive | Example 3, | Example 4, |
| | Example 2 | without fixation | blank |
| ΔE | 1.53 | 5.98 | 7.24 |

### Inventive Preparation Example 3—Preparation of a Colorant Catcher Material According to the Present Invention Comprising a Viscose Substrate

A polyvinylamine solution was prepared by mixing 0.556 litre of water with 444 grams of Solution C (a 22.5% aqueous solution of polyvinylamine having a weight average molecular weight Mw of 45,000). A separate solution was prepared by mixing 0.95 litre of water with 50 grams of glutaraldehyde. A piece of 100% viscose spunlaced nonwoven fabric with a weight of 50 grams/m² was impregnated into a bath containing the polyvinylamine solution, then passed through one roller at a pressure of 4 bar with the uploading rate of 100%. Next, the fabric was impregnated into a bath containing said solution of glutaraldehyde for 3 seconds, and finally dried in an oven at 120° C. for 3 minutes. Compared with initial fabric, the weight increase of final finished fabric is 12.5%.

### Inventive Preparation Example 3.3—Preparation of a Colorant Catcher Material According to the Present Invention Comprising a Wood Pulp Blend Substrate

A polyvinylamine solution was prepared by mixing 0.556 litre of water with 444 grams of Solution C (a 22.5% aqueous solution of polyvinylamine having a weight average molecular weight Mw of 45,000). A separate solution was prepared by mixing 0.95 litre of water with 50 grams of glutaraldehyde. A piece of woodpulp spunlace composite nonwoven (50% woodpulp, 20% PET fiber, 30% viscose fiber) fabric with a weight of 50 grams/m2 was impregnated into a bath containing the solution of polyvinylamine, then passed through one roller at a pressure of 4 bar with the uploading rate of 105%. Next, the fabric was impregnated into a bath containing said solution of glutaraldehyde for 3 seconds, and finally dried in an oven at 120° C. for 3 minutes. Compared with initial fabric, the weight increase of final finished fabric is 12%.

### Inventive Preparation Example 4—Preparation of a Colorant Catcher Material According to the Present Invention Comprising a Viscose Substrate

A polyvinylamine solution was prepared by mixing 0.556 litre of water with 444 grams of Solution C (a 22.5% aqueous solution of polyvinylamine having a weight average molecular weight Mw of 45,000). A separate solution was prepared by mixing 0.95 litre of water with 50 grams of glyoxal. A piece of 100% viscose spunlaced nonwoven fabric with a weight of 50 grams/m² was impregnated into a bath containing the polyvinylamine solution, then passed through one roller at a pressure of 4 bar with the uploading rate of 100%. Next, the fabric was impregnated into a bath containing said solution of glyoxal for 3 seconds, and finally dried in an oven at 120° C. for 3 minutes. Compared with initial fabric, the weight increase of final finished fabric is 11.9%.

### Comparative Preparation Example 5—Preparation of a Colorant Catcher Material without Treatment with Fixing Agent Comprising a Viscose Substrate

A polyvinylamine solution was prepared by mixing 0.556 litre of water with 444 grams of Solution C (a 22.5% aqueous solution of polyvinylamine having a weight average molecular weight Mw of 45,000). A piece of 100% viscose spunlaced nonwoven fabric with a weight of 50 grams/m² was impregnated into a bath containing the polyvinylamine solution, then passed through one roller at a pressure of 4 bar with the uploading rate at 100%. Then, the fabric was dried in an oven at 120° C. for 3 minutes. Compared with initial fabric, the weight increase of final finished fabric is 10%.

Washing Test

A dye solution was prepared by mixing 0.5 grams of C.I. Disperse Blue 56 and 0.5 grams of C.I. Reactive Blue 19 in one litre of water. A sheet of the colorant catcher material (3 g) from Inventive Example 3, Inventive Example 4 or Comparative Example 5 and a sheet of white cotton woven fabric (3 g) were immersed into a bath containing 30 g of said dye solution, and then stirred at 23° C. for 10 minutes. The fabrics were removed from the bath. The white cotton woven fabric was dried and measured for the color change in terms of ΔE as described above.

### Comparative Example 6 (Blank)

The washing test was repeated except that no colorant catcher material was used.

The results are shown in Table 3.

TABLE 3

| | | | | Comparative | |
|---|---|---|---|---|---|
| | | | | Example 5, | Comparative |
| | Inventive | Inventive | Inventive | without | Example 6, |
| | Example 3 | Example 3.3 | Example 4 | fixation | blank |
| ΔE | 1.29 | 1.01 | 3.47 | 6.11 | 7.35 |

It can be seen from the results given in Tables 1 to 3, the colorant catcher materials of the Inventive Examples show a very good dye catching capability, as indicated by a ΔE reduction of about 5.4 (Inventive Example 1 vs. Comparative Example 2), of about 5.7 (Inventive Example 2 vs. Comparative Example 4), of about 6.1 (Inventive Example 3 vs. Comparative Example 6), or of about 3.9 (Inventive Example 4 vs. Comparative Example 6). In case of the colorant catcher materials of the Inventive Examples, dye transferring was significantly and effectively inhibited. The results given in Tables 1 to 3 also show that fixation of the dye catching additive by the fixing agent is essential to achieve the high dye catching capability and thus the high dye transferring inhibiting effect.

Further, it can be seen that the colorant catcher materials of the Inventive Examples are not only effective for catching a reactive dye, but also effective for a disperse dye.

### Further Application Examples

### Inventive Application Example 5

An effluent sample was collected from a cloth printing plant with a solid content in water of 12 g/L. The main solid content in this effluent is a mixture of pigments and thickener. The effluent sample was diluted into additional water to have a solid content of 0.5 g/L, which is in a color of light brown. A sheet of colorant catcher material (5 g) as prepared in Inventive Example 4 was immersed into a bath containing 100 grams of said diluted effluent sample, and then stirred at 80° C. for 3 minutes.

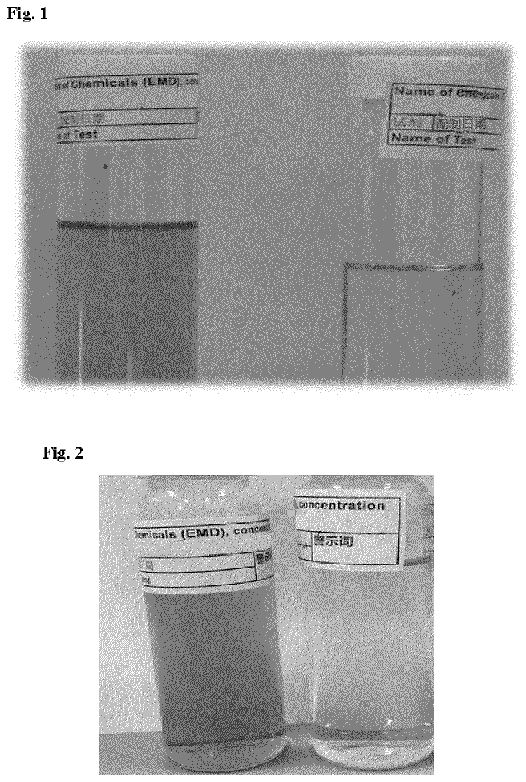

FIG. 1 shows appearances of the effluent sample from a cloth printing plant as described above before the treatment with the sheet of colorant catcher material according to Inventive Example 5 (left) and after the treatment (right). As shown, the effluent sample after treatment with the colorant catcher material was observed very pale beige and clearer.

### Inventive Application Example 6

An effluent sample was collected from a cloth dyeing plant with a solid content in water of 6.4 g/L. The main solid content in this effluent is a mixture of disperse dyes and reactive dyes. The effluent sample was diluted into additional water to have a solid content of 0.04 g/L, which is in a color of purple. A sheet of colorant catcher material (2.5 g) as prepared in Inventive Example 2 was immersed into a bath containing 100 grams of said diluted effluent sample, and then stirred at 80° C. for 2 minutes.

FIG. 2 shows appearances of the effluent sample from a cloth dyeing plant as described above before the treatment with the sheet of colorant catcher material according to Inventive Example 6 (left) and after the treatment (right). As shown, the effluent sample after treatment with the colorant catcher material was observed almost colorless.

### Inventive Application Example 7

The anti-bacterial activity of colorant catcher material according to the present invention was evaluated based on standard testing method ASTM E2149-13a (“Standard Test Method for Determining the Antimicrobial Activity of Antimicrobial Agents Under Dynamic Contact Conditions” available e.g. from the American Society for Testing and Materials under http://www.astm.org/), a test method designed to evaluate the antimicrobial activity of nonleaching, antimicrobial-treated specimens under dynamic contact conditions.

An aqueous test solution was prepared by diluting a bacterial culture broth of Escherichia coli (ATCC 25922), or Saphylococcus aureus (ATCC6538) respectively, in water to obtain a final concentration of 1.5-3.0×10⁵ CFU/ml. A sheet of the colorant catcher material (0.5 g) from Inventive Example 1, Inventive Example 3 or Comparative Example 2 was immersed into a bath containing 50 ml of said respective bacterial solution, and then stirred at 25° C. for 60 minutes. The fabrics were removed from the bath. The remained respective bacterial solution was analysed to measure the reduced concentration of bacteria in comparison with a blank sample. The results are given in table 4.a below.

TABLE 4.a

| | | | Comparative |
|---|---|---|---|
| Bacterial | Inventive | Inventive | Example 2 |
| strain | Example 1 | Example 3 | (blank) |
| E. Coli | >99.9% | >99.9% | <0.1% |
| (ATCC 25922) | | | |
| S. aureaus | >99.9% | >99.9% | <0.1% |
| (ATCC 6538) | | | |

For testing the capability of the colorant catcher of the present application for multiple applications (repeated use), the colorant catcher material of inventive example 1, or inventive example 3 respectively, was washed five (5) times according to washing standard GB/T 8629-2001 (“Textiles-Domestic washing and drying procedures for textile testing” (eqv to ISO 6330:2000); selecting Type A washer, washing procedure “gentle cycle” (no. 7A), drying procedure “F” (oven drying at 60° C.), phosphorus-free ECE standard detergent as detergent and 100% cotton bleach woven fabric as ballast fabric). The results are given in table 4.b below.

TABLE 4.b
(after 5x standard washing according GB/T 8629-2001):

| Bacterial | Inventive | Inventive |
|---|---|---|
| strain | Example 1 | Example 3 |
| E. Coli | >99.9% | >99.9% |
| (ATCC 25922) | | |
| S. aureaus | >99.9% | >99.9% |
| (ATCC 6538) | | |

As can be shown in tables 4.a and 4.b above, the colorant catcher according to the present invention demonstrates very good anti-bacterial performance uder the test conditions, which still persisted after the 5 tested standardized washing cycles

1. A colorant catcher material, comprising:
a) a substrate,
b) a colorant-catching additive selected from the group consisting of polyvinylamines in form of homopolymers, copolymers and/or partial salts thereof, polyethylenimines in form of homopolymers, copolymers and/or partial salts thereof, and mixture thereof, which is fixed on the substrate by
c) a fixing agent selected from the group consisting of dialdehydes with a carbon number of from 2 to 8.

2. The colorant catcher material according to claim 1, wherein the polyvinylamines have a weight-average molecular weight of from 1,000 to 1,000,000.

3. The colorant catcher material according to claim 1, wherein the polyethylenimines have a weight-average molecular weight of from 300 to 10,000,000.

4. The colorant catcher material according to claim 1, wherein the fixing agent is selected from the group consisting of glyoxal, malondialdehyde, succinaldehyde, glutaraldehyde, adipaldehyde, and a mixture thereof.

5. The colorant catcher material according to claim 4, wherein the fixing agent is selected from the group consisting of glyoxal and glutaraldehyde.

6. The colorant catcher material according to claim 1, wherein the substrate is a natural and/or a synthetic fabric.

7. The colorant catcher material according to claim 1, wherein the substrate is a non-woven fabric made of fibers selected from polyester, lyocell, tencell, cotton, viscose, and mixture thereof.

8. The colorant catcher material according to claim 1, wherein the substrate is a non-woven fabric made of fiber blends comprising fibers selected from the group consisting of polyester, polypropylene (PP), polyethylene terephthalate (PET), lyocell, cotton and viscose.

9. The colorant catcher material according to claim 1, wherein the substrate is a non-woven fabric made of wood pulp comprising additional fibers selected from the group consisting of polyester, polypropylene (PP), polyethylene terephthalate (PET), lyocell, cotton and viscose.

10. A method for producing the colorant catcher material as defined in claim 1, comprising
a) Providing a substrate;
b) Incorporating a colorant-catching additive into the substrate, the colorant-catching additive being selected from the group consisting of polyvinylamines in form of homopolymers, copolymers and/or partial salts thereof, polyethylenimines in form of homopolymers, copolymers and/or partial salts thereof, and mixture thereof, to obtain a substrate loaded with the colorant-catching additive;
c) Optionally, removing any excess colorant-catching additive from the substrate loaded with the colorant-catching additive, and
d) Further treating the substrate loaded with the colorant-catching additive with a fixing agent selected from the group consisting of dialdehydes with a carbon number of from 2 to 8.

11. The method for producing the colorant catcher material according to claim 10, further comprising a step e) for drying the treated substrate from step d).

12. The method for producing the colorant catcher material according to claim 10, wherein the colorant-catching additive is incorporated into the substrate in step b) by impregnation, spraying, printing and/or plating with a solution of the colorant-catching additive.

13. The method for producing the colorant catcher material according to claim 10, wherein the substrate loaded with the colorant-catching additive is treated with the fixing agent in step c) by impregnation or spraying.

14. The method for producing the colorant catcher material according to claim 10, wherein the colorant-catching additive in step b) is in form of an aqueous solution.

15. The method for producing the colorant catcher material according to claim 10, wherein the fixing agent in step c) is in form of an aqueous solution.

16. The method for producing the colorant catcher material according to claim 12, wherein the solution of the colorant-catching additive contains a nonionic surfactant selected from long chain alcohol polyethylene glycol/polypropylene glycol ethers or long chain alcohol polypropylene glycol/polyethylene glycol ethers, fatty acid C1-10 alkyl esters, amine oxides, long chain alcohol alkoxylates, wherein the long chain alcohols are selected from fatty alcohols such as Guerbet alcohols, cetyl alcohol, stearyl alcohol, and cetostearyl alcohol consisting predominantly of cetyl and stearyl alcohols, and oleyl alcohol.

17-20. (canceled)

21. A method for catching colorants present in an aqueous medium, the method comprising use of the colorant catcher material as defined in claim 1.

22. A method for removing dirt or dirt particles present in an aqueous medium, the method comprising use of the colorant catcher material as defined in claim 1.

23. A method for disinfecting laundry or reducing or preventing bacterial laundry contamination, such as from pathogenic bacteria present in an aqueous medium, the method comprising use of the colorant catcher material as defined in claim 1.

24. A method for scavenging gases, the method comprising use of the colorant catcher material as defined in claim 1.
